(19) United States
(12) Patent Application Publication
(10) Pub. No.: US 2026/0018087 A1
(43) Pub. Date: Jan. 15, 2026

(54) Display device

(71) Applicant: CHAMP VISION DISPLAY INC., MIAO-LI COUNTY (TW)

(72) Inventors: LI-WEN CHANG, MIAO-LI COUNTY (TW); CHEN-TSUN JUAN, MIAO-LI COUNTY (TW)

(21) Appl. No.: 19/263,420

(22) Filed: Jul. 8, 2025

(30) Foreign Application Priority Data
Jul. 11, 2024 (TW) 113207453

(51) Int. Cl. G09F 9/37

(52) U.S. Cl. CPC G09F 9/37

(57) ABSTRACT

A display device is adapted to optionally mount an outer frame. The display device includes a housing and a moving component. The housing includes a first portion and a second portion connected to the first portion. The first portion has an opening slot, and the second portion has an opening. The moving component includes a positioning element and an operating element. The operating element is movably disposed in the opening slot. The positioning element is connected to the operating element and has a positioning end facing the opening. The positioning end is adapted to optionally mount the outer frame. The operating element is adapted to drive the positioning element to move from a first position to a second position, so that the positioning end extends from the opening to the outside of the housing or retracts into the housing.

### CROSS-REFERENCE TO RELATED APPLICATION

This application claims the priority benefit of Taiwan application (No. 113207453), filed on Jul. 11, 2024. The entirety of the above-mentioned patent application is hereby incorporated by reference herein and made a part of this specification.

### TECHNICAL FIELD

The disclosure relates to an electronic device, and more particularly to a display device.

### BACKGROUND

The parts of a display device can be roughly divided into appearance parts and internal parts, wherein the internal parts are mainly electronic components and optical components, and appearance parts are mainly an outer frame and a back cover. Generally, the internal parts mainly affect the image quality of the display device, and the appearance parts affect the appearance design of the display device.

However, in the prior art, the appearance parts of the display device are connected to each other, and a part of the appearance parts are further connected to the internal parts, which causes difficulty to disassemble one of the appearance parts of the display device as it needs to be replaced, and the appearance parts and/or the internal parts may easily be damaged during the process of disassembling. Additionally, the display devices with different sizes or models are unable to share the same appearance parts. Hence, once the appearance design of the display device needs to be changed, the only way is to redesign a new set of appearance parts and discard the original appearance parts, thereby increasing the product cost.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

In order to achieve one or a portion of or all of the objects or other objects, an embodiment of the disclosure provides a display device that is adapted to optionally mount an outer frame. The display device includes a housing and a moving component. The housing includes a first portion and a second portion connected to the first portion. The first portion has an opening slot, and the second portion has an opening. The moving component includes a positioning element and an operating element. The operating element is movably disposed in the opening slot. The positioning element is connected to the operating element and has a positioning end facing the opening. The positioning end is adapted to be optionally connected to the outer frame. The operating element is adapted to drive the positioning element to move from a first position to a second position, and makes the positioning end extend out of the housing from the opening or retract into the housing from the opening.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a display device in an embodiment of the disclosure;

FIG. 2 is a partial schematic cross-sectional view of the display device, taken along the line A-A in FIG. 1;

FIG. 3 is a schematic diagram of a positioning end in FIG. 2 being separated from the outer frame;

FIG. 4 is a partial schematic diagram of the display device in

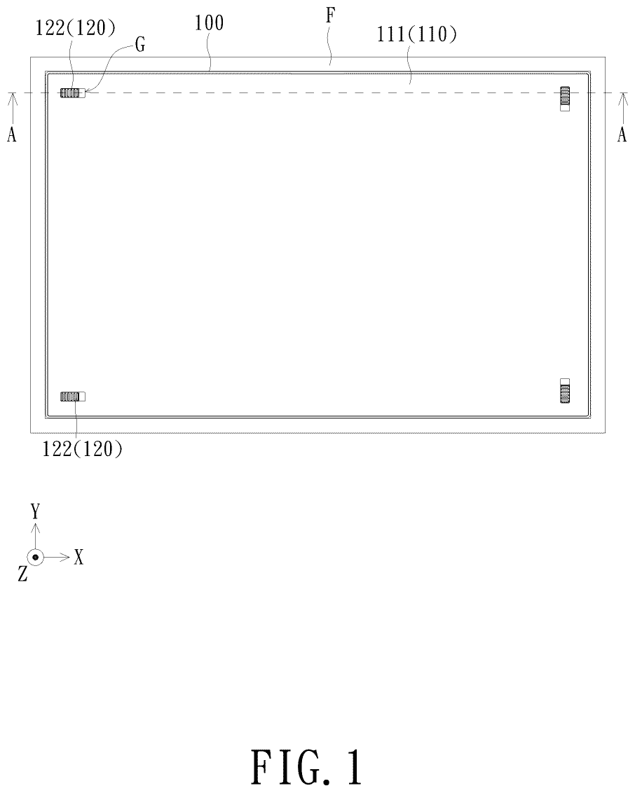

FIG. 1;

FIG. 5 is a schematic cross-sectional view of a display device in another embodiment of the disclosure;

FIG. 6 is a schematic cross-sectional view of a display device in another embodiment of the disclosure;

FIG. 7 is a schematic cross-sectional view of a display device in another embodiment of the disclosure; and

FIG. 8 is a schematic cross-sectional view of a display device in another embodiment of the disclosure.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

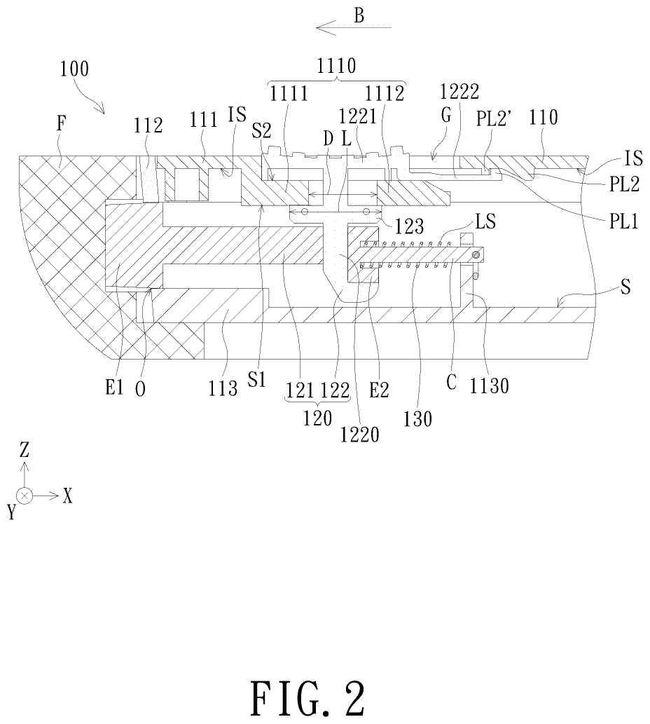

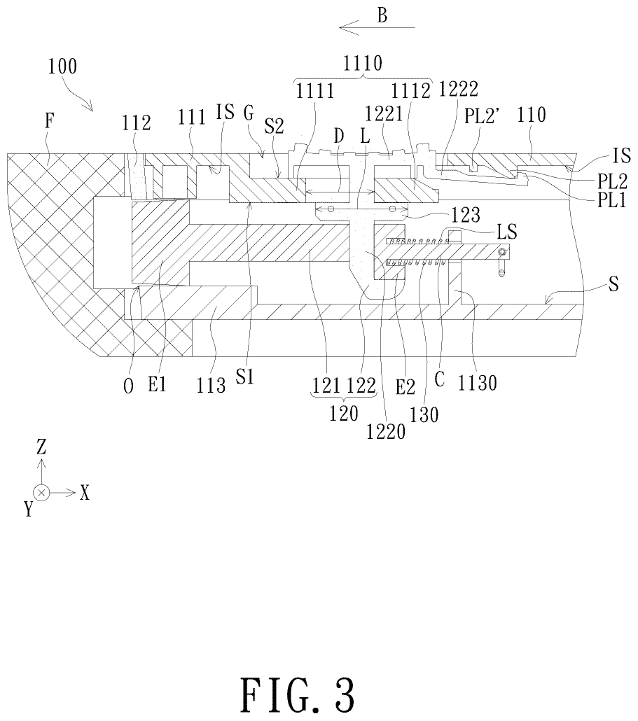

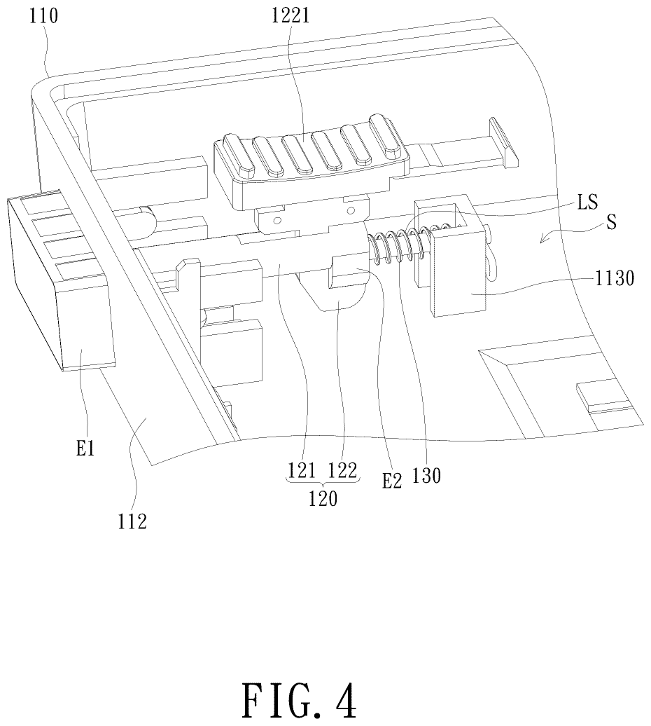

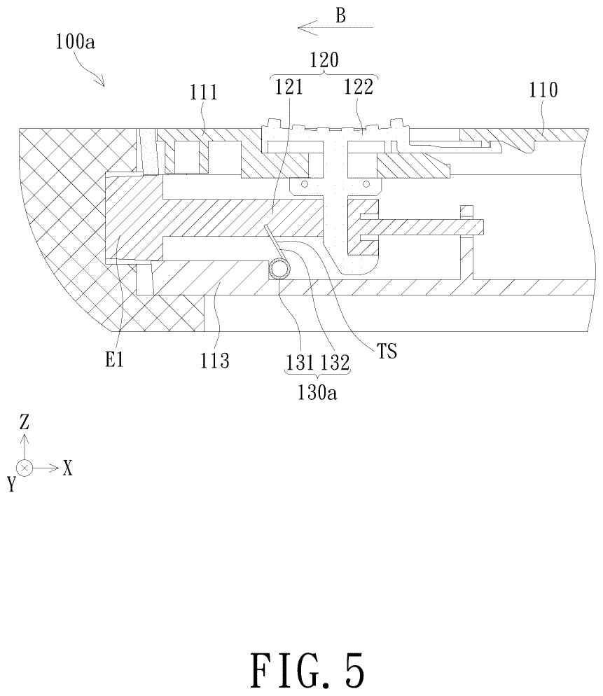

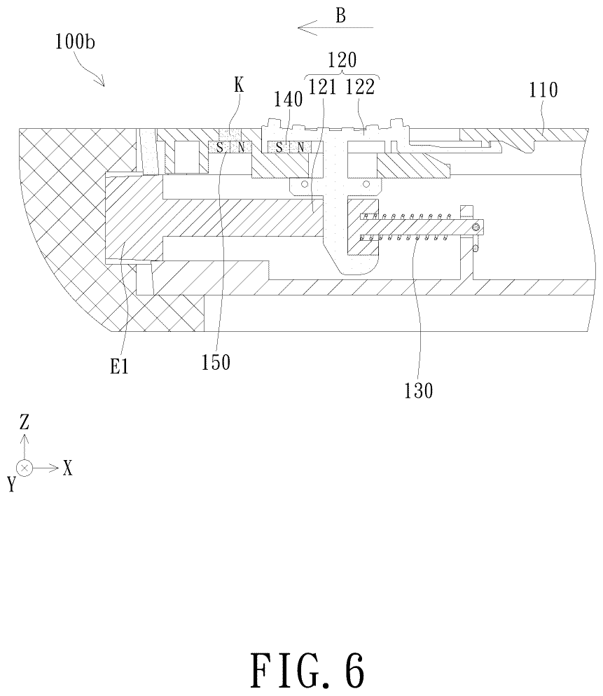

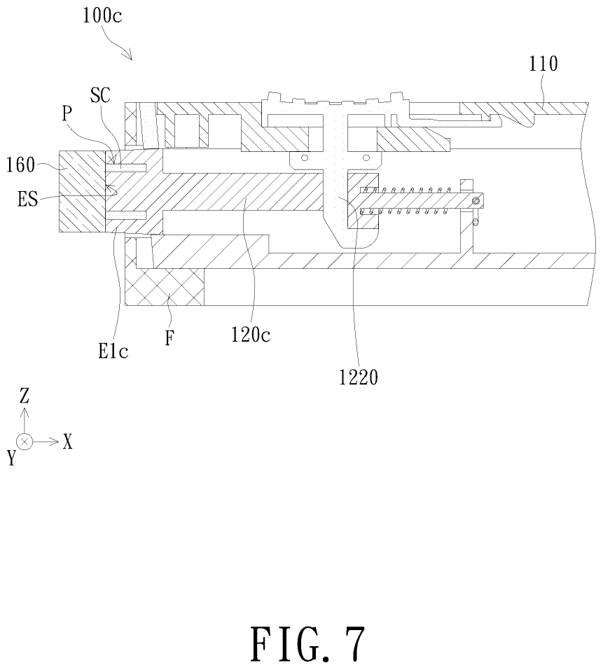

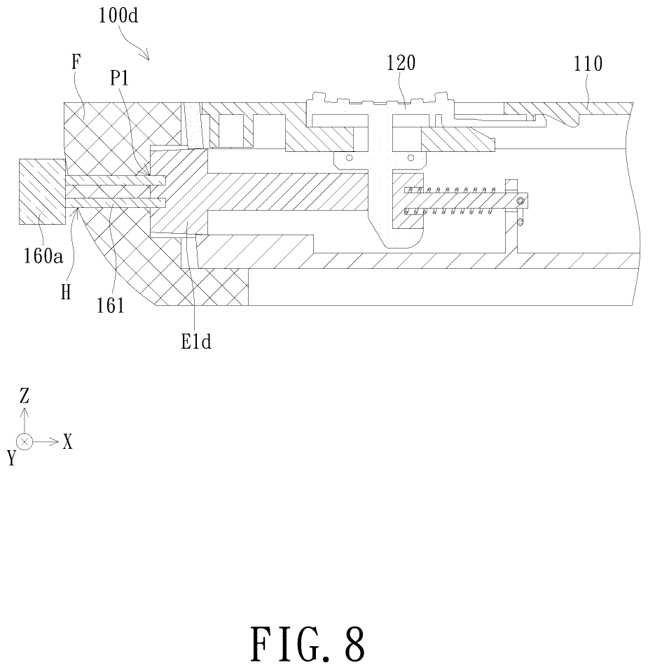

FIG. 1 is a schematic diagram of a display device in an embodiment of the disclosure. FIG. 2 is a partial schematic cross-sectional view of the display device, taken along the line A-A in FIG. 1. FIG. 3 is a schematic diagram of a positioning end in FIG. 2 being separated from the outer frame. FIG. 4 is a partial schematic diagram of the display device in FIG. 1. Referring to FIGS. 1, 2, and 3, a display device 100 is adapted to optionally mount an outer frame F. The display device 100 includes a housing 110 and a moving component 120. The housing 110 includes a first portion 111 and a second portion 112 connected to the first portion 111. The first portion 111 has an opening slot G, and the second portion 112 has an opening O. The moving component 120 includes a positioning element 121 and an operating element 122. The operating element 122 is movably disposed in the opening slot G. The positioning element 121 is connected to the operating element 122 and has a positioning end E1 facing the opening O. The positioning end E1 is adapted to be optionally connected to the outer frame F. The operating element 122 is adapted to drive the positioning element 121 to move from a first position to a second position and makes the positioning end E1 extend out of the housing 110 from the opening O (shown in FIG. 2) or retract into the housing 110 from the opening O (shown in FIG. 3). For example, the positioning end E1 in this embodiment is retracted into the housing 110 when moving from the first position to the second position. The positioning end E1 is retracted into the housing 110 when the positioning element 121 is at the second position. Herein, the positioning end E1 is retracted into the housing 110 on a reference plane parallel to the Y-axis and the Z-axis, and the positioning end E1 does not protrude from the housing 110. That is, the end surface of the positioning end E1 may be flush with the outer side of the second portion 112 on the reference plane. Alternatively, the end surface of the positioning end E1 may be a concave surface with respect to the outer side of the second portion 112. At least a part of the positioning end E1 is located outside the housing 110 when the positioning element 121 is located at the first position. The display device 100 is a display, and the display device 100 may include, for example, a display panel and a backlight module. The display may be, for example, a liquid-crystal display (LCD), an organic light-emitting display (OLED), or a plasma display panel (PDP).

As shown in FIG. 1, the display device 100 uses, for example, four sets of moving components 120, and each of the moving components 120 is respectively disposed along an edge of the first portion 111 of the housing 110. The number and positions of the moving components 120 may be adjusted according to the requirements in practice in other embodiments.

Referring to FIGS. 2 and 3 again, the operating element 122 of the moving component 120 can have a connecting part 1220 and an operating part 1221 in this embodiment. The operating part 1221 is movably disposed in the opening slot G, and the connecting part 1220 is connected to the operating part 1221 and located in the housing 110. The operating part 1221 is, for example, a slide switch. Specifically, the operating part 1221 may be exposed outside the housing 110 from the opening slot G to allow a user to operate and move it. The positioning element 121 is fixed to the operating element 122 and moves together with the operating element 122, so that the positioning end E1 can extend out of the housing 110 or retract into the housing 110. The positioning end E1 extending out of the housing 110 allows the outer frame F to be mounted to the housing 110, and the outer frame F can be dissembled by retracting the positioning end E1 into the housing 110. The outer frame F may be provided with a groove corresponding to the positioning end E1. Referring to FIGS. 2 and 4, the positioning end E1 may be in the shape of a block, and the positioning end E1 is inserted into the groove of the outer frame F to allow the outer frame F to be more stably mounted. The block may be formed by a plurality of plates arranged at intervals, but other embodiments are not limited thereto. The operating element 122 in this embodiment is, for example, adapted to be separated from the positioning element 121, so that the moving component 120 can be easily assembled and disassembled.

Referring to FIGS. 2 and 3 again, the first portion 111 (also shown in FIG. 1) of the housing 110 is, for example, a back cover, the first portion 111 has an inner surface IS, and the inner surface IS is located in the housing 110. The second portion 112 of the housing 110 (also shown in FIG. 4) may be a frame, and the frame may be combined with a side of the back cover. In other words, the operating element 122 of the moving component 120 may be exposed from the back cover, and the positioning end E1 of the positioning element 121 may extend out of the housing 110 from the frame. The first portion 111 and the second portion 112 may not be limited to the back cover and the frame in other embodiments and may be other components of the housing 110.

The first portion 111 of the housing 110 can further have a supporting structure 1110 in this embodiment, and the supporting structure 1110 has a first surface S1 and a second surface S2. The second surface S2 faces the opening slot G, and the first surface S1 faces away from the opening slot G. The operating part 1221 is adapted to move against the second surface S2 of the supporting structure 1110. The moving component 120 has, for example, a blocking part 123. The operating part 1221 and the connecting part 1220 are respectively connected to two opposite sides of the blocking part 123, and the blocking part 123 is adapted to move against the first surface S1. The operating part 1221 and the blocking part 123 can be respectively against two opposite sides of the supporting structure 1110 (i.e., the second surface S2 and the first surface S1) when the operating element 122 drives the positioning end E1 to move between the first position and the second position, so it is able to make the operating element 122 more stably move and prevents the operating element 122 from turning or being askew due to the uneven force during movement. For example, the force applied by an elastic component 130 on the operating element 122 is more concentrated on the connecting part 1220 in this embodiment. Hence, the blocking part 123 can abut against the first surface S1 of the supporting structure 1110 when the operating element 122 moves, to prevent the operating element 122 from moving toward the direction Z due to excessive force applied on the connecting part 1220.

The supporting structure 1110 of the first portion 111 of the housing 110 can include a first segment 1111 and a second segment 1112. The first segment 1111 and the second segment 1112 are arranged along a direction X (opposite to the direction B) from the first position pointing to the second position and are separated by a gap D in the direction B. The blocking part 123 is adapted to move against the first segment 1111 and the second segment 1112. The blocking part 123 has a length L in the direction B, and the length L is greater than the gap D. Thus, it is ensured that the blocking part 123 can be kept being against the first segment 1111 and the second segment 1112 when the operating element 122 moves, so that the operating element 122 can move more stably and can be further prevented from turning or being askew due to the uneven force during movement. The length L is, for example, a distance between the two opposite ends of the blocking part 123 in this embodiment. Additionally, the blocking part 123 may be divided into two segments corresponding to the first segment 1111 and the second segment 1112, and the two segments may be respectively against the first segment 1111 and the second segment 1112. It should be noted that the first surface S1 and the second surface S2 are located on two opposite sides of the first segment 1111, and the first surface S1 and the second surface S2 respectively extend from the first segment 1111 to the second segment 1112. The operating element 122 can move back and forth along the direction B by the gap D between the first segment 1111 and the second segment 1112.

On the other hand, the inner surface IS of the first portion 111 can be connected to the supporting structure 1110. The operating element 122 further has, for example, a position-limiting part 1222. The position-limiting part 1222 is connected to the operating part 1221 and is adapted to move against and between the inner surface IS and the supporting structure 1110. For example, the position-limiting part 1222 can move against the inner surface IS and the second surface S2 of the second segment 1112 to prevent the operating element 122 from falling off the opening slot G. The inner surface IS and the second surface S2 of the supporting structure 1110 may face two opposite directions; for example, the second surface S2 in this embodiment faces the direction Z, and the inner surface IS faces a direction opposite to the direction Z. When the operating element 122 drives the positioning end E1 to move between the first position and the second position, a part of the position-limiting part 1222 may be against the inner surface IS of the first portion 111, and a part of the position-limiting part 1222 may be against the second surface S2 of the supporting structure 1110. The position-limiting part 1222 can have the first position-limiting structure PL1 being against the inner surface IS, and the inner surface IS has the second position-limiting structures PL2 and PL2′ corresponding to the first position-limiting structure PL1. Thus, when the positioning end E1 moves to the first position (shown in FIG. 2), the first position-limiting structure PL1 of the position-limiting part 1222 can be against the second position-limiting structure PL2′ of the inner surface IS, thereby letting the movement of the positioning end E1 be stopped at the second position. Similarly, when the positioning end E1 moves to the second position (shown in FIG. 3), the first position-limiting structure PL1 of the position-limiting part 1222 can be against the second position-limiting structure PL2 of the inner surface IS, thereby letting the movement of the positioning end E1 stop at the second position. The first position-limiting structure PL1 and the second position-limiting structures PL2 and PL2′ all are, for example, convex structures in this embodiment. The housing 110 can further include a third portion 113. The third portion 113 and the first portion 111 are respectively connected to two opposite sides of the second portion 112, and the positioning element 121 is located between the first portion 111 and the third portion 113. The inner surface IS of the first portion 111 may be a surface of the first portion 111 facing the third portion 113 but does not include the supporting structure 1110.

The display device 100 can further include the elastic component 130 in this embodiment. The elastic component 130 is connected to the housing 110 and the moving component 120, and the elastic component 130 is adapted to drive the positioning element 121 to return from the second position to the first position. For example, the positioning end E1 can extend out of the housing 110 after being driven by the elastic component 130 to return to the first position. The number of the elastic components 130 may be the same as the number of the moving components 120. For example, the display device 100 may use four sets of elastic components 130 to match four sets of moving components 120.

The elastic component 130 in this embodiment may include a linear spring LS. The linear spring LS can be, for example, a compression spring or a tension spring. The third portion 113 has, for example, a surface S and a spring base 1130, wherein the third portion 113, the surface S, and the spring base 1130 are also shown in FIG. 4. The surface S faces the first portion 111 of the housing 110, and the spring base 1130 is located on the surface S. The positioning element 121 further has an end E2 (shown in FIG. 4), and the end E2 faces away from the positioning end E1 and faces the spring base 1130. The linear spring LS is connected to the spring base 1130 and the end E2 to pull or push the operating element 122 from the spring base 1130. For example, a compression spring is used as the linear spring LS, the operating element 122 can be manually moved along the direction X to drive the positioning end E1 to move from the first position to the second position and to make the positioning element 121 compress the linear spring LS from the spring base 1130. After the positioning end E1 moves to the second position and the first position-limiting structure PL1 is stuck by the second position-limiting structure PL2 (shown in FIG. 3), the first position-limiting structure PL1 can be manually detached from the second position-limiting structure PL2. Hence, the operating element 122 is pulled by an elastic restoring force of the linear spring LS and moves along the direction B, thereby making the positioning end E1 return to the first position (shown in FIG. 2).

It can be understood that the operating element 122 may be manually moved in the direction X to drive the positioning element 121 to move from the first position (shown in FIG. 3) to the second position (shown in FIG. 2) when a tension spring is used as the linear spring LS in an embodiment, so that the linear spring LS is stretched by the positioning element 121 and the spring base 1130. Thus, the linear spring LS can push the operating element 122 to move along the direction B (shown in FIG. 2). When the positioning end E1 is moved to the second position (shown in FIG. 2), the first position-limiting structure PL1 of the operating element 122 abuts against the second operating element structure PL2′, and the first position-limiting structure PL1 abuts against the second position-limiting structure PL2′ in sequence along the X direction, and the second position-limiting structure PL2′ can provide a reaction force of the first position-limiting structure PL1 along the direction B, so that the first position-limiting structure PL1 can be fixed to the second position-limiting structure PL2′. After the positioning end E1 is moved to the second position, the first position-limiting structure PL1 can be manually disengaged from the second position-limiting structure PL2′, so that the operating element 122 is driven by an elastic restoring force of the linear spring LS to move along the direction X, thereby returning the positioning end E1 to the first position (shown in FIG. 3). The elastic component 130 may be omitted from the display device 100 in another embodiment, and the moving component 120 may be manually moved along the direction B or X. The spring base 1130 in this embodiment may be provided with a column C for the linear spring LS to be set. The end E2 and the positioning end E1 of the positioning element 121 may be located on two opposite sides of the connecting part 1220.

Compared with the prior art, the display device 100 in this embodiment uses the moving component 120, wherein the operating element 122 of the moving component 120 can be actuated to move. Specifically, the operating element 122 can drive the positioning end E1 to extend out of the housing 110 for mounting the outer frame F and further drive the positioning end E1 to retract into the housing 110 for disassembling the outer frame F. Thus, the display device 100 in this embodiment not only has the advantage that the appearance parts are easy to be replaced but also reduces the cost of changing the appearance design.

For example, the material of the housing 110 may include plastic, and the material of the outer frame F may include wood. The outer frame F is mounted outside the housing 110 through the positioning end E1 and covers the housing 110 to make the display device 100 have the visual effect of wooden frame decoration, so the display device 100 can be used as a digital photo frame or a digital picture frame. The material of the outer frame F may also include metal, plastic, silicone, glass, and other materials in other embodiments to be used as a decorative frame of the display device 100.

FIG. 5 is a schematic cross-sectional view of a display device in another embodiment of the disclosure. The structure and advantages of the display device 100a in this embodiment are similar to those of the embodiment in FIG. 2, and only the differences are described below. Referring to FIG. 5, the elastic component 130a can include a torsion spring TS, and the torsion spring TS can have a torsion part 131 and an actuated part 132. The torsion part 131 is fixed to a side of the third portion 113 facing the first portion 111 (such as the surface S), and the actuated part 132 is connected to the torsion part 131 and the positioning element 121. The moving component 120 can be driven by the torsion spring TS to move in the direction B or X, making the positioning end E1 extend out of the housing 110 or retract into the housing 110. For example, the torsion spring TS in this embodiment can drive the moving component 120 to move along the direction X, making the positioning end E1 retract into the housing 110.

FIG. 6 is a schematic cross-sectional view of a display device in another embodiment of the disclosure. The structure and advantages of the display device 100b in this embodiment are similar to those of the embodiment in FIG. 2, and only the differences are described below. Referring to FIG. 6, the display device 100b further includes, for example, a first magnetic component 140 and a second magnetic component 150. The first magnetic component 140 is fixed to the moving component 120. The second magnetic component 150 is fixed to the housing 110 and is adapted to drive the first magnetic component 140 to drive the positioning element 121 to move between the first position and the second position. For example, when the S pole of the first magnetic component 140 faces the N pole of the second magnetic component 150, the first magnetic component 140 can be attracted by the second magnetic component 150 to move along the direction B, thereby driving the positioning element 121 to move along the direction B to make the positioning end E1 extend out of the housing 110. On the contrary, when the N pole of the first magnetic component 140 faces the N pole of the second magnetic component 150, the first magnetic component 140 can be repelled by the second magnetic component 150 to move along the direction X, thereby driving the positioning element 121 to move along the direction X to make the positioning end E1 retract into the housing 110. The second magnetic component 150 can be connected to a knob K to change the position of the N pole/S pole of the second magnetic component 150 by the knob K, so as to attract or repel the first magnetic component 140. The first magnetic component 140 is, for example, a permanent magnet, and the second magnetic component 150 may be an electromagnet. Hence, the direction of the magnetic field of the second magnetic component 150 can be changed by energizing the second magnetic component 150, and the knob K may be omitted. The moving component 120 can be driven to move more smoothly by the elastic component 130 with the first magnetic component 140 in this embodiment. The elastic component 130 may be omitted from the display device 100b in another embodiment.

FIG. 7 is a schematic cross-sectional view of a display device in another embodiment of the disclosure. The structure and advantages of the display device 100c in this embodiment are similar to those in the embodiment in FIG. 2, and only the differences are described below.

Referring to FIG. 7, the positioning end E1c of the moving component 120c has an end surface ES, and the end surface ES faces away from the connecting part 1220. The end surface ES can have a positioning structure P, and the positioning structure P can be adapted to mount an expansion component 160 to gain the scalability of the display device 100c. The positioning structure P can be sunken into the end surface ES to form an open hole. For example, the positioning structure P may be a screw hole, and the expansion component 160 may be screwed to the positioning structure P by screws SC. The expansion component 160 can include at least one of an infrared sensor, a light sensor, a camera lens, a color corrector, and a gesture recognition sensor, but the disclosure is not limited thereto. The positioning structure P may be designed to enhance the mounting firmness of the outer frame F in an embodiment. For example, the outer frame F may be provided with a convex pillar corresponding to the positioning structure P. The outer frame F may have an opening corresponding to the positioning end E1c in this embodiment, and the positioning end E1c may protrude from the outer frame F. The end surface ES in this embodiment may use the same color or material as the outer frame F to maintain a consistent appearance. In this embodiment, the display device 100c does not need to mount the outer frame F.

FIG. 8 is a schematic cross-sectional view of a display device in another embodiment of the disclosure. The structure and advantages of the display device 100d in this embodiment are similar to those in the embodiment in FIG. 7, and only the differences are described below. Referring to FIG. 8, an expansion component 160a of the display device 100d is disposed on the positioning end E1d, and the outer frame F can be disposed between the expansion component 160a and the positioning end E1d. The outer frame F may have a through hole H corresponding to the positioning structure P1 of the positioning end E1d, and the expansion component 160a may have a protruded pillar 161 corresponding to the positioning structure P1 and the through hole H. The protruded pillar 161 may be a screw. The protruded pillar 161 can be fixed to the positioning structure P1 and the through hole H, so that the expansion component 160a is fixed to the outer frame F and the positioning end E1d and is located outside the housing 110 for operation or use. The positioning end E1d may not be provided with the positioning structure P1 in an embodiment, and the protruded pillar 161 of the expansion component 160a may be fixed to the through hole H of the outer frame F. The through hole H of the outer frame F may be a screw hole in another embodiment.

In summary, the display device in the embodiments of the disclosure has at least one of the following advantages. The display device of the disclosure uses the moving component, wherein the operating element of the moving component can drive the positioning end to extend out of the housing for mounting the outer frame and further can drive the positioning end to retract into the housing for disassembling the outer frame. Thus, the display device of the disclosure not only has the advantage that the appearance parts are easy to be replaced, but also reduces the cost of changing the appearance design.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A display device, adapted to optionally mount an outer frame, the display device comprising:
a housing, comprising a first portion and a second portion connected to the first portion, the first portion having an opening slot, and the second portion having an opening; and
a moving component, comprising a positioning element and an operating element, the operating element being movably disposed in the opening slot, the positioning element being connected to the operating element and having a positioning end facing the opening, and the positioning end being adapted to be optionally connected to the outer frame;
wherein the operating element is adapted to drive the positioning element to move from a first position to a second position and makes the positioning end extend out of the housing from the opening or retract into the housing from the opening.

2. The display device according to claim 1, wherein:
the first portion of the housing further has a supporting structure, the supporting structure has a first surface and a second surface, the second surface faces the opening slot, and the first surface faces away from the opening slot;
the operating element of the moving component has a connecting part and an operating part, the operating part is movably disposed in the opening slot, the connecting part is connected to the operating part and is located in the housing, and the operating part is adapted to move against the second surface of the supporting structure;
the moving component has a blocking part, the operating part and the connecting part are respectively connected to two opposite sides of the blocking part, and the blocking part is adapted to move against the first surface.

3. The display device according to claim 2, wherein the supporting structure of the first portion of the housing comprises a first segment and a second segment, the first segment and the second segment are arranged along a direction from the first position pointing to the second position and are separated by a gap in the direction, the blocking part is adapted to move against the first segment and the second segment, the blocking part has a length in the direction, and the length is greater than the gap.

4. The display device according to claim 2, wherein the first portion has an inner surface, the inner surface is connected to the supporting structure, the operating element further has a position-limiting part, the position-limiting part is connected to the operating part and is adapted to move against and between the inner surface and the supporting structure.

5. The display device according to claim 4, wherein the position-limiting part has a first position-limiting structure against the inner surface, and the inner surface has a second position-limiting structure corresponding to the first position-limiting structure.

6. The display device according to claim 1, further comprising an elastic component, wherein the elastic component is connected to the housing and the moving component, and the elastic component is adapted to drive the positioning element to return from the second position to the first position.

7. The display device according to claim 6, wherein:
the elastic component comprises a linear spring, the housing further comprises a third portion, the third portion and the first portion are respectively connected to two opposite sides of the second portion, the positioning element is located between the first portion and the third portion, the third portion has a surface and a spring base, the surface faces the first portion of the housing, and the spring base is located on the surface;
the positioning element further has an end, the end faces away from the positioning end and faces the spring base, and the linear spring is connected to the spring base and the end.

8. The display device according to claim 6, wherein the elastic component comprises a torsion spring, the housing further comprises a third portion, the third portion and the first portion are respectively connected to two opposite sides of the second portion, the positioning element is located between the first portion and the third portion, the torsion spring has a torsion part and an actuated part, the torsion part is fixed to a side of the third portion facing the first portion, and the actuated part is connected to the torsion part and the positioning element.

9. The display device according to claim 1, wherein the operating element is adapted to be separated from the positioning element.

10. The display device according to claim 1, further comprising a first magnetic component and a second magnetic component, wherein the first magnetic component is fixed to the moving component, and the second magnetic component is fixed to the housing and is adapted to drive the first magnetic component to drive the positioning element to move between the first position and the second position.

11. The display device according to claim 1, wherein the positioning end has an end surface, the end surface faces away from the connecting part, and the end surface has a positioning structure.

12. The display device according to claim 1, further comprising an expansion component, wherein the expansion component is disposed on the positioning end.

13. The display device according to claim 12, wherein the expansion component comprises at least one of an infrared sensor, a light sensor, a camera lens, a color corrector, and a gesture recognition sensor.

14. The display device according to claim 12, wherein the display device comprises the outer frame, and the outer frame is disposed between the expansion component and the positioning end.
